(19) United States
(12) Patent Application Publication
(10) Pub. No.: US 2008/0301386 A1
(43) Pub. Date: Dec. 4, 2008

(54) REMOTE COPY SYSTEM AND REMOTE COPY CONTROL METHOD

(76) Inventors: Akira MATSUI, Yokohama (JP); Kengo IKEDA, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/016,220

(22) Filed: Jan. 18, 2008

(30) Foreign Application Priority Data
Jun. 4, 2007 (JP) 2007-148055

(51) Int. Cl. G06F 12/16

(52) U.S. Cl. 711/162; 711/E12.103

(57) ABSTRACT

Providing a remote copy system for performing remote copy between a plurality of sites each constituted by a plurality of storage subsystems, wherein even if sub-data volumes at the remote site belong to the different storage subsystems, the update order of data copied from the main site to these sub-data volumes can be maintained in these sub-data volumes. Pieces of update data for a plurality of primary data volumes at the main site are sequenced and collectively stored in a common primary journal volume, the pieces of update data in the primary journal volume are remote-copied to a sub-journal volume shared by a plurality of storage subsystems at the remote site, the pieces of update data in the sub-journal volume are sorted in a time order and allocated to a plurality of sub-data volumes belonging to different storage subsystems to be written therein.

### CROSS-REFERENCES TO RELATED APPLICATIONS

This application relates to and claims priority from Japanese Patent Application No. 2007-148055, filed on Jun. 4, 2007, the entire disclosure of which is incorporated herein by reference.

### BACKGROUND

1. Field of the Invention

The invention relates generally to a remote copy system.

2. Description of Related Art

In recent years, the demand for disaster recovery in storage systems has increased. A known technique for meeting that demand is employing a remote copy system where data in a storage system at a main site is copied to a storage system at a remote site without involving a host computer (JP11-085408 A).

Modes for remote copy include: a synchronous remote copy mode where update data a host computer sends to a duplication source data volume is reflected in that volume and concurrently in a duplication destination data volume; and an asynchronous remote copy mode where a buffer (journal volume) is provided at both the main site and the remote site for temporarily storing update data, the update data stored in the journal volume at the main site is stored in the journal volume at the remote site non-concurrently with the storing of the update data in the journal volume at the main site, the pieces of update data are sorted, at the remote site, in the order they were updated in the duplication source data volume and then written in the duplication destination data volume. Incidentally, the duplication source data volume is the primary data volume in a copy pair, while the duplication destination data volume is the sub-data volume in the copy pair.

Regarding asynchronous remote copy, JP2005-196618 A discloses a technique whereby, a plurality of primary data volumes in one storage subsystem at the main site is set as a group; and the order the host computer updates data in the primary data volumes in the same group at the main site is guaranteed for the corresponding data in a plurality of sub-data volumes in one storage subsystem at the remote site.

With conventional techniques, there is a problem that, when a storage system includes more than one storage subsystem at the remote site and each storage subsystem includes sub-data volumes, the update order of update data copied from the main site cannot be guaranteed in the sub-data volumes belonging to different storage subsystems because no means is provided for having the storage subsystems report each other's data update order.

In light of this problem, the invention aims to provide a remote copy system for performing remote copy between a plurality of sites each consisting of more than one storage subsystem, the remote copy system being capable of guaranteeing the update order of data copied from the main site in the sub-data volumes at the remote site even if the sub-data volumes at the remote site belong to more than one storage subsystem.

### SUMMARY

In order to achieve the above object, this invention provides a remote copy system wherein pieces of update data for a plurality of primary data volumes at the main site are sequenced and collected in a common primary journal volume, the pieces of update data in the primary journal volume are remote-copied to a sub-journal volume common to a plurality of storage subsystems at the remote site, and the pieces of update data in the sub-journal volume are sorted in a time order and allocated to a plurality of sub-data volumes belonging to a plurality of storage subsystems to be written therein.

According to this invention, in a system for performing remote copy between a plurality of sites each constituted by a plurality of storage subsystems, even if sub-data volumes at the remote site belong to a plurality of storage subsystems, the update order of data copied from the main site to these sub-data volumes can be maintained in these sub-data volumes.

Other aspects and advantages of the invention will be apparent from the following description and the appended claims.

### BRIEF DESCRIPTION OF THE DRAWINGS

FIG. 1 is a hardware block diagram showing an embodiment of a remote copy system according to the invention.

FIG. 2 is a block diagram illustrating the details of a copy control program in a host computer.

FIG. 3 shows a storage management table.

FIG. 4 shows a table for managing the settings and statuses of paths between the storage subsystems.

FIG. 5 shows a table for managing consistency groups.

FIG. 6 shows a journal volume management table.

FIG. 7 shows a pair management table for managing the information for pair relationships between primary data volumes (duplication source data volumes) and sub-data volumes (duplication destination data volumes) in the remote copy system.

FIG. 8 is a flowchart explaining the operations performed based on a copy information setting program in the host computer to make settings for remote copy.

FIG. 9 is a hardware block diagram of a storage subsystem at a main/remote site, including a data/journal volume.

FIG. 10 is a table for managing update data numbers assigned in a primary journal volume-only storage subsystem.

FIG. 11 is a flowchart explaining the controls executed by an I/O control unit in storage-controlling hardware.

FIG. 12 is a flowchart explaining the controls executed by a copy status control unit.

FIG. 13 is a flowchart explaining the operations performed by a storage control unit in a primary data volume-only storage subsystem.

FIG. 14 is a flowchart explaining the controls executed by a storage control unit in a primary journal volume-only storage subsystem when receiving update data from the primary data volume-only storage subsystem.

FIG. 15 is a flowchart explaining the controls executed by the storage control unit in the primary journal volume-only storage subsystem when transferring update data to a sub-journal volume-only storage subsystem.

FIG. 16 is a flowchart explaining the controls executed by the storage control unit in the sub-journal volume-only storage subsystem when receiving update data from the primary journal volume-only storage subsystem.

FIG. 17 is a flowchart explaining the controls executed by the storage control unit in the sub-journal volume-only storage subsystem when transferring update data to the sub-data volume-only storage subsystem.

FIG. 18 is a flowchart explaining the controls executed by the storage control unit in the sub-data volume-only storage subsystem.

FIG. 19 shows, as an example, changes made to the information in a consistency group management table when a failure occurs in an in-use sub-journal volume.

FIG. 20 is a chart showing the formation formula for data to be stored from a primary journal volume to a sub-journal volume.

### DETAILED DESCRIPTION OF PREFERRED EMBODIMENTS

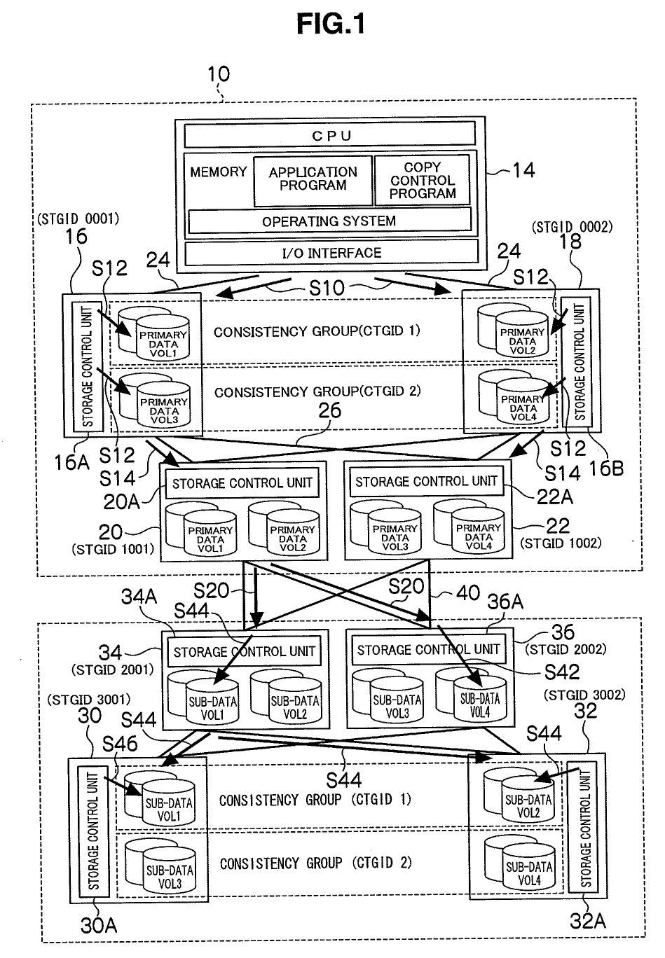

FIG. 1 is a hardware block diagram showing an embodiment of a remote copy system according to the invention. This remote copy system consists of a first storage system 10 constituting a main site and a second storage system 12 constituting a remote site.

The remote copy system enables remote copy between the main site and the remote site, each consisting of a plurality of storage subsystems, while maintaining the order of data update commands in the main site by a host computer 14, even at the remote site.

For that purpose, in the remote copy system in FIG. 1, the pieces of update data the host computer sends to a plurality of primary data volumes at the main site are collected in primary journal volumes common to the primary data volumes and the pieces of update data are reflected in a plurality of sub-data volumes at the remote site using sub-journal volumes common to the sub-data volumes. In the remote copy system in FIG. 1, asynchronous remote copy is performed between the primary journal volumes and sub-journal volumes.

In the remote copy system in FIG. 1, the primary journal volumes are formed in storage subsystems different from those having the primary data volumes, while the sub-journal volumes are formed in storage subsystems different from those having the sub-data volumes.

Details of the remote copy system in FIG. 1 will be explained below. The first storage system 10 includes a host computer 14, a first primary data volume-only storage subsystem 16 (STGID0001), second primary data volume-only storage subsystem 18 (STGID0002), first primary journal volume-only storage subsystem 20 (STGID1001), and second primary journal volume-only storage subsystem 22 (STGID1002). The codes in the brackets are the storage subsystem IDs.

The host computer 14 is connected to the first primary data volume-only storage subsystem 16 and the second primary data volume-only storage subsystem 18 via communication paths 24. These storage subsystems are each connected to the first primary journal volume-only storage subsystem 20 and the second primary journal volume-only storage subsystem 22, via communication paths 26.

The host computer 14 includes a CPU, memory, and I/O interface. The memory stores an application program, copy control program, and an operating system.

The first primary data volume-only storage subsystem 16 includes a storage control unit 16A, a primary data volume (primary VOL1), and another primary data volume (primary VOL3). The second primary data volume-only storage subsystem 18 includes a storage control unit 18A, a primary data volume (primary VOL2), and another primary data volume (primary VOL4).

The storage control units 16A and 16B are in charge of controlling the input/output of data between the primary data volume-only storage subsystems and the host computer as well as between the primary data volume-only storage subsystems and the primary journal volume-only storage subsystems.

The primary data volumes are logical memory areas the memory devices in the storage subsystems provide to the host computer. The same holds true for later-mentioned sub-data volumes.

There is no particular limitation regarding what to call these logical memory areas—volumes, logical devices, or logical disks. A preferable example of the memory devices is hard disk drives but they may alternatively be semiconductor memory such as flash memory.

The primary data volume VOL1 and primary data volume VOL2 form a first consistency group (CTGID1) where the order of data update by the host computer is guaranteed; the primary data volume VOL3 and primary data volume VOL4 form a second consistency group (CTGID2) where the data for the data update by the host computer is guaranteed.

The first primary journal volume-only storage subsystem 20 includes a storage control unit 20A, a primary journal volume (primary JNL1), and another primary journal volume (primary JNL2).

The second primary journal volume-only storage subsystem 22 includes a storage control unit 22A, a primary journal volume (primary JNL3), and another primary journal volume (primary JNL4).

Pieces of update data the host computer sends to the primary data volume VOL1 and primary data volume VOL2 are stored in the primary journal volume JNL1 in the order the host computer issued the update commands for those pieces of update data. The same pieces of update data are also stored in the primary journal volume JNL4. Likewise, pieces of update data sent to the primary data volume VOL3 and primary data volume VOL4 are stored in the primary journal volume JNL2 and primary journal volume JNL3.

The primary journal volume storage subsystem 22 is an alternative for the primary journal volume-only storage subsystem 20. In other words, the primary journal volume JNL4 is an alternative for the primary journal volume JNL1. The primary journal volume JNL3 is an alternative for the primary journal volume JNL2.

Input from the host computer to a primary data volume, inputs from the storage control unit in a primary data volume-only storage subsystem to the primary data volume, and inputs from the primary data volume-only storage subsystem to a primary journal volume are processed concurrently.

Each of the primary data volumes (primary VOL1 to primary VOL4) and primary journal volumes (primary JNL1 to primary JNL4) consists of one or more volumes.

The second storage system 12 includes a first sub-data volume-only storage subsystem 30, second sub-data volume-only storage subsystem 32, first sub-journal volume-only storage subsystem 34, and second sub-journal volume-only storage subsystem 36.

The first sub-data volume-only storage subsystem 30 (STGID3001) includes a storage control unit 30A, a sub-data volume (sub-VOL1), and another sub-data volume (sub-VOL3). The second sub-data volume-only storage subsystem 32 (STGID3002) includes a storage control unit 32A, a sub-data volume (sub-VOL2), and another sub-data volume (sub-VOL4).

The first sub-journal volume-only storage subsystem 34 (STGID2001) includes a storage control unit 34A, a sub-journal volume (sub-JNL1), and another sub-journal volume (sub-JNL2). The second sub-journal volume-only storage subsystem 36 (STGID2002) includes a storage control unit 36A, a sub-journal volume (sub-JNL3), and another sub-journal volume (sub-JNL4).

The sub-data volume VOL1 has a copy pair relationship with the primary data volume VOL1 while the sub-data volume VOL2 has a copy pair relationship with the primary data volume VOL2. In other words, the sub-data volume VOL1 and sub-data volume VOL2 form a consistency group corresponding to the consistency group (CTGID1) consisting of the primary data volume VOL1 and primary data volume VOL2.

Likewise, the sub-data volume VOL3 has a copy pair relationship with the primary data volume VOL3 while the sub-data volume VOL4 has a copy pair relationship with the primary data volume VOL4. In other words, the sub-data volume VOL3 and sub-data volume VOL4 form a consistency group corresponding to the consistency group (CTGID2) consisting of the primary data volume VOL3 and primary data volume VOL4.

The second sub-journal volume-only storage subsystem 36 is an alternative for the first sub-journal volume-only storage subsystem 34. The sub-journal volume JNL4 is an alternative for the sub-journal volume JNL1, while the sub-journal volume JNL3 is an alternative for the sub-journal volume JNL2.

The second storage system 12 is located away from the first storage system 10 and they are connected via long-distance communication paths 40. With these communication paths, the in-service primary journal volume-only storage subsystem 20 and its alternative primary journal volume-only storage subsystem 22 in the first storage system 10 are connected to the in-service sub-journal volume-only storage subsystem 34 and its alternative sub-journal volume-only storage subsystem 36 in the second storage system 12, respectively.

The data in the primary journal volume JNL1 is remote-copied to the sub-journal volume JNL1 and sub-journal volume JNL4. Input (S20) from the primary journal volume-only storage subsystem 20 to the sub-journal volume-only storage subsystems 34 and 36 is performed non-concurrently with the input (S10) by the host computer. The data in the primary journal volume JNL2 is remote-copied to the sub-journal volume JNL2 and sub-journal volume JNL3. The reference code S42 indicates a write command from the storage control unit 34A (36A) in the sub-journal volume-only storage subsystem 34 (36) to the sub-journal volume.

When a failure occurs in the first primary journal volume-only storage subsystem 20, the second primary journal volume-only storage subsystem 22 is set as an in-service system; asynchronous remote copy is performed for the data in the primary journal volume JNL3 to the sub-journal volume JNL2 and sub-journal volume JNL3; and asynchronous remote copy is performed for the data in the primary journal volume JNL4 to the sub-journal volume JNL1 and sub-journal volume JNL4.

Remote copy between the storage systems 10 and 12 may alternatively performed in a manner that the storage control unit 34A in the in-service sub-journal volume-only storage subsystem 34 accesses the storage control unit 20A in the in-service primary journal volume-only storage subsystem non-concurrently with the access by the host computer.

When a failure occurs in an in-service storage subsystem, the corresponding alternative storage subsystem is set as an in-service storage subsystem and performs remote copy.

The storage control unit 34A in the sub-journal volume-only storage subsystem 34 sequentially reads the data in the sub-journal volume JNL1; sends the update data for the primary data volume VOL1 to the storage control unit 30A in the first sub-data volume-only storage subsystem 30; and sends the update data for the primary data volume VOL2 to the storage control unit 32A in the second sub-data volume-only storage subsystem 32.

So the update data for the primary data volume VOL1 is written in the sub-data volume VOL1 and the update data for the primary data volume VOL2 is written in the sub-data volume VOL2. Reference code S44 indicates input from the sub-journal volume-only storage subsystems to the sub-data volume-only storage subsystems. Reference code S46 indicates input from the storage control units in the sub-data volume-only storage subsystems to the sub-data volumes.

Just as in the case of the sub-journal volume JNL1, of the data in the sub-journal volume JNL2, the update data for the primary data volume VOL3 is written in the sub-data volume VOL3 and the update data for the primary data volume VOL4 is written in the sub-data volume VOL4.

Every time update data is received for a primary data volume concurrently with the corresponding input by the host computer, the storage control unit 20A in the first primary journal volume-only storage subsystem 20 assigns a serial number (update data number), which is managed for each consistency group, to the update data. This provides time order-related attributes to the update of the primary data volume VOL1 and the update of the primary data volume VOL2 in the same consistency group CTGID1. Time order-related attributes are also provided to the update of the primary data volume VOL3 and the update of the primary data volume VOL4 in the consistency group CTGID2.

The storage control unit 34A in the sub-journal volume-only storage subsystem 34 refers to the update data numbers assigned to the pieces of update data in the sub-journal volume JNL1; sorts the pieces of update data in the order of their update data numbers; and transfers them to the sub-data volume VOL1 or sub-data volume VOL2. The same holds true for the sub-journal volume JNL2, and the storage control unit 34A writes the pieces of update data in the sub-data volume VOL3 or sub-data volume VOL4.

Accordingly, with the remote copy system in FIG. 1, the time order of data update in the primary data volumes VOL1 and VOL2 can be maintained also in the sub-data volumes VOL1 and VOL2 belonging to the same consistency group CTGID1. Likewise, the time order of data update in the primary data volumes VOL3 and VOL4 can be maintained also in the sub-data volumes VOL3 and VOL4 belonging to the same consistency group CTGID2.

When a failure occurs in the first primary journal volume-only storage subsystem 20, its alternative second primary journal volume-only storage subsystem 22 takes over the function as the first primary journal volume-only storage subsystem. Also, when a failure occurs in a path to only one of the primary journal volumes in the first primary journal volume-only storage subsystem 20, the second primary journal volume-only storage subsystem 22 takes over the I/O processing function only for the faulty primary journal volume. The same holds true for the sub-journal volume-only storage subsystems 34 and 36. In that case, the sub-journal volume VOL3 is associated with the sub-data volume VOL3 and sub-data volume VOL4 while the sub-journal volume JNL4 is associated with the sub-data volume VOL1 and sub-data volume VOL2.

Update data the host computer 14 sends to a primary data volume is reflected in the primary data volume via a cache memory in a storage control unit. When a primary data volume-only storage subsystem stores the update data in a primary journal volume, it sends a command completion report to the host computer 14.

Although the input (S20) from a primary journal volume-only storage subsystems to a sub-journal volume-only storage subsystem is processed non-concurrently with the relevant input by the host computer, writing (S42) from the storage control unit in the sub-journal volume-only storage subsystem to the sub-journal volume JNL1, input (S44) from the sub-journal volume storage subsystem to a relevant sub-data volume-only storage subsystem, and input (S46) from the storage control unit 30A to a relevant sub-data volume are processed concurrently.

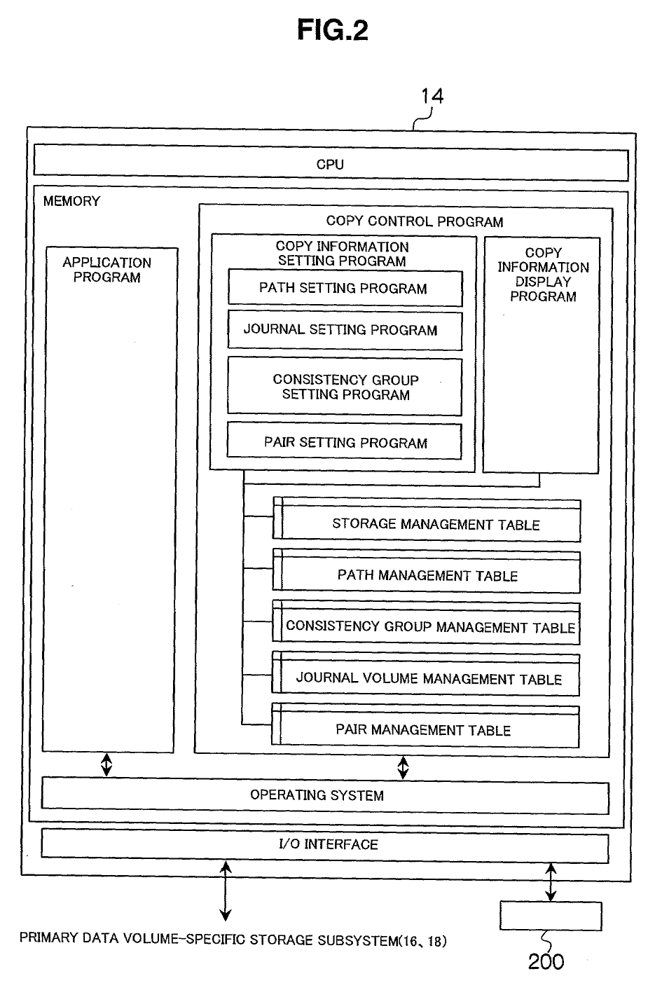

FIG. 2 is a block diagram illustrating the details of a copy control program in a host computer. The reference numeral 200 indicates a terminal device of the host computer.

The CPU reads and runs the programs (operating system, application program, copy control program) in the memory. Examples of the application program include an online program and database program. The copy control program further includes a copy information setting program for setting information for the remote copy, as well as an information display program.

The copy information setting program further includes a path setting program, journal setting program, consistency group setting program, and a pair setting program. The path setting program is for setting paths between the storage subsystems for remote copy. The information on path settings is registered and managed in a path management table.

The journal setting program is for setting journal volumes at the main site and remote site. The information for the journal volume settings is registered in a journal volume management table.

The consistency group setting program is for setting consistency groups, more specifically, for setting IDs of consistency groups as well as journal volumes belonging to those consistency groups. The information for these settings is registered in a consistency group management table.

The pair setting program is for setting pairs for remote copy. Pair settings are made by designating pair-making primary/sub data volumes and consistency groups (CTGIDs) the pairs belong to. The information for the pair settings is registered in a pair management table.

The copy information display program is for displaying the information in the tables used for remote copy on a display of the terminal device.

Explanations will be given below for the control information the copy control program and copy information display program in the host computer refer to when executing control. The control information is, as described above, the storage management table, path management table, consistency group management table, journal volume management table, and pair management table.

These management tables are sent from the host computer to the storage subsystems at the main site and remote site and stored in their memories. The terminal device 200 is used to set these management tables in the host computer. The same holds true for other management tables.

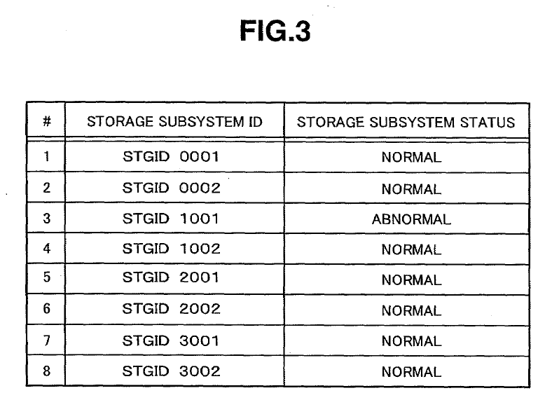

FIG. 3 shows the storage management table. Each storage subsystem is identified by its ID and its status is shown as either normal or abnormal. The host computer refers to this storage management table when making various settings, such as path settings and journal volume settings, etc.

If there is an abnormality in any of the in-service primary journal volume-only storage subsystems, that abnormal storage subsystem is switched over to an alternative storage subsystem, with reference to the storage management table. The same holds true for the sub-journal volume-only storage subsystems.

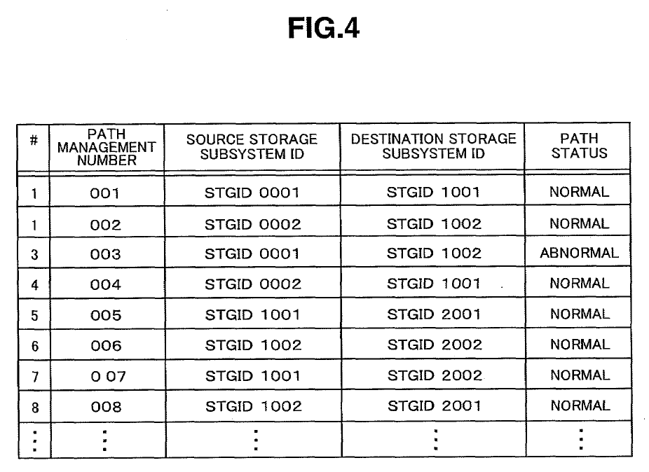

FIG. 4 shows the table for managing the settings and statuses of paths between the storage subsystems. Paths are set between the primary data volume-only storage subsystems and the primary journal volume-only storage subsystems, between the primary journal volume-only storage subsystems and the sub-journal volume-only storage subsystems, and between the sub-journal volume-only storage subsystems and the sub-data volume-only storage subsystems, in the manner shown in FIG. 4. If any of the paths is in an abnormal state, the relevant in-service subsystem is switched over to its corresponding alternative subsystem.

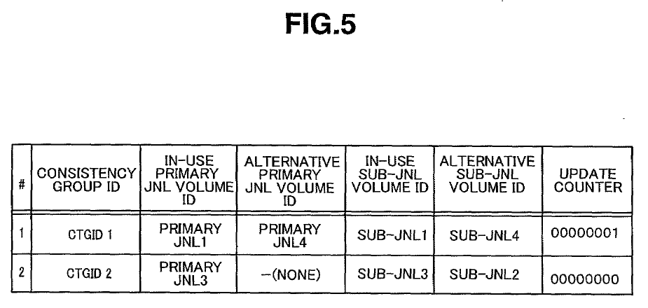

FIG. 5 shows the table for managing the consistency groups. This management table is for managing the consistency groups and the journal volumes belonging to these consistency groups. As shown in FIG. 1, the consistency group (CTGID1) consists of the primary data volumes VOL1 and VOL2 and sub-data volumes VOL1 and VOL2. As described above, the time order of the data update by the host computer in the primary data volumes VOL1 and VOL2 is guaranteed also in the sub-data volumes VOL1 and VOL2.

As shown in FIGS. 1 and 5, in the consistency group (CTGID1), the primary journal volume JNL1 serves as an in-service (in-use) primary journal volume and the sub-journal volume JNL1 serves as an in-service sub-journal volume. Each journal volume has been assigned an alternative journal volume.

An in-service journal volume-only storage subsystem is switched over to an alternative journal volume-only storage subsystem, depending on its status or the status of paths. This switch involves updating of the consistency group management table in FIG. 5. The update history is managed by an update counter.

In FIG. 1, when a failure occurs in the storage subsystem having the primary journal volume JNL2, the primary journal volume JNL2 is switched over to its alternative primary journal volume JNL3. Here, in the consistency group management table, the status of the primary journal volume JNL3 is switched from alternative to in-use, and the ID of the primary journal volume JNL3 is registered in the in-use primary journal volume ID section. Meanwhile, “none” is registered in the alternative primary journal volume section, indicating that there is no volume serving as an alternative primary journal volume. For the above registration, the update counter is incremented by one. The storage subsystems at the main site and remote site refer to the consistency group management table in order to recognize the in-service primary journal volumes and sub-journal volumes.

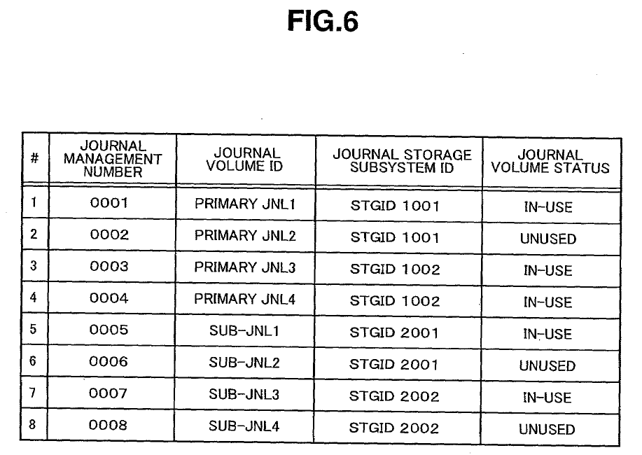

FIG. 6 shows the journal volume management table. This table is for managing the information for the journal volumes. For each journal volume serial number, the ID of the journal volume, the ID of the storage subsystem that journal volume belongs to, and the status of the journal volume are registered.

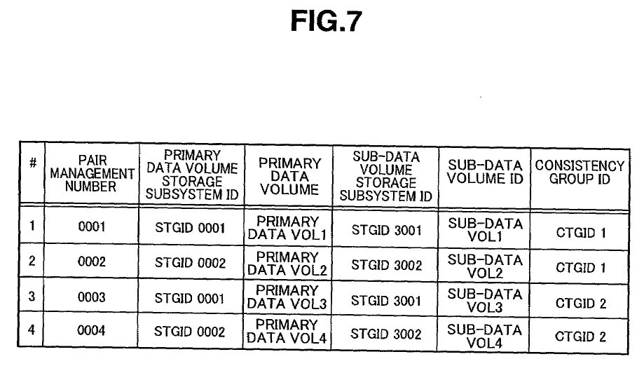

FIG. 7 shows the pair management table for managing the information for the pair relationships between the primary data volumes (duplication source data volumes) and sub-data volumes (duplication destination data volumes) in the remote copy system. As can be seen from this pair management table, the primary data volume and the sub-data volume belonging to the same pair management number section form a pair in the remote copy.

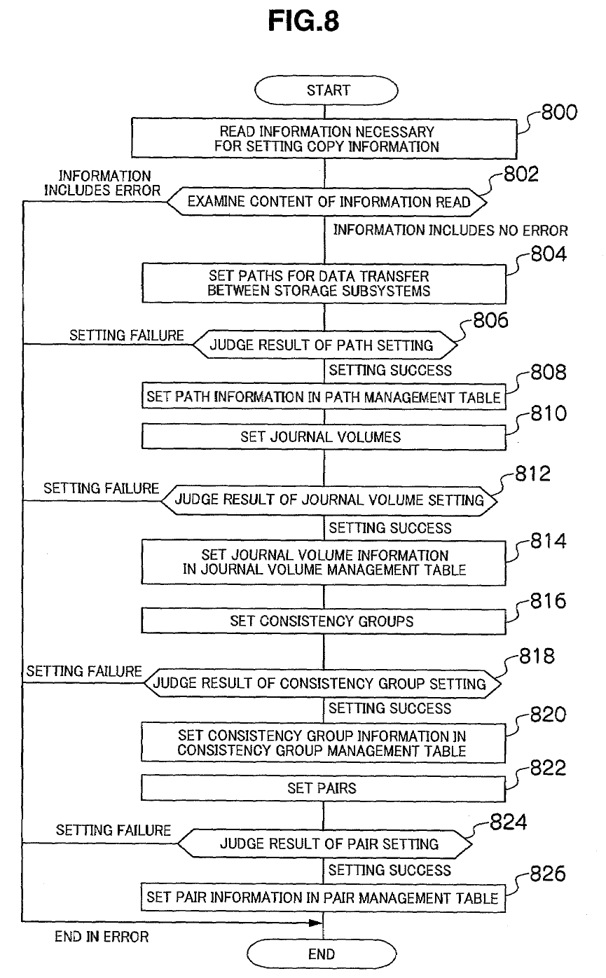

FIG. 8 is a flowchart explaining the operations performed based on the copy information setting program in the host computer to make settings for remote copy. Although the host computer performs various processing other than remote copy setting, such as displaying remote copy information and input/output processing after setting remote copy, displaying of the remote copy information only involves outputting the tables shown in FIG. 3-FIG. 7 to the terminal and the input/output processing is the same as the usual processing regardless of the remote copy settings (the host computer is not aware of the remote copy settings), so explanations for that processing will be omitted. The processing in this flowchart is executed by the CPU in the host computer based on the copy information setting program.

In STEP800, the host computer reads the information necessary for setting the remote copy information from the parameters created in the volumes of the storage subsystems as well as the inputs from the terminal device.

The host computer examines the content of the information it has read (STEP802). If the content includes an error, the flowchart ends in error. If there is no error, the host computer makes settings for paths for data transfer between the storage subsystems (STEP804). Actual path setting is performed by the storage subsystems.

In STEP806, the result of the path setting is judged. If the setting fails, the flowchart is terminated, whereas if the setting succeeds, the host computer registers the path information in the path management table (STEP 808). The host computer then makes settings for journal volumes in STEP 810. Actual journal volume setting is performed by the storage subsystems.

In STEP812, the result of the journal volume setting is judged. If the setting fails, the processing is terminated whereas if the setting succeeds, the host computer registers the journal volume information in the journal volume management table (STEP814).

In STEP816, the host computer makes settings for consistency groups. Actual consistency group setting is performed by the storage subsystems.

In STEP818, the result of the consistency group setting is judged. If the setting fails, the flowchart ends in error. Meanwhile, if the setting succeeds, the host computer registers the consistency group information in the consistency group management table and the journal volume management table (STEP820).

In STEP822, the storage subsystems perform pair setting. In STEP824, the host computer judges the result of the pair setting. If the setting fails, the flowchart ends in error whereas if the setting succeeds, the host computer registers the pair information in the pair management table (STEP826).

By following the flowchart in FIG. 8, various settings required for the remote copy are set among the host computer and the storage subsystems at the main site and remote site.

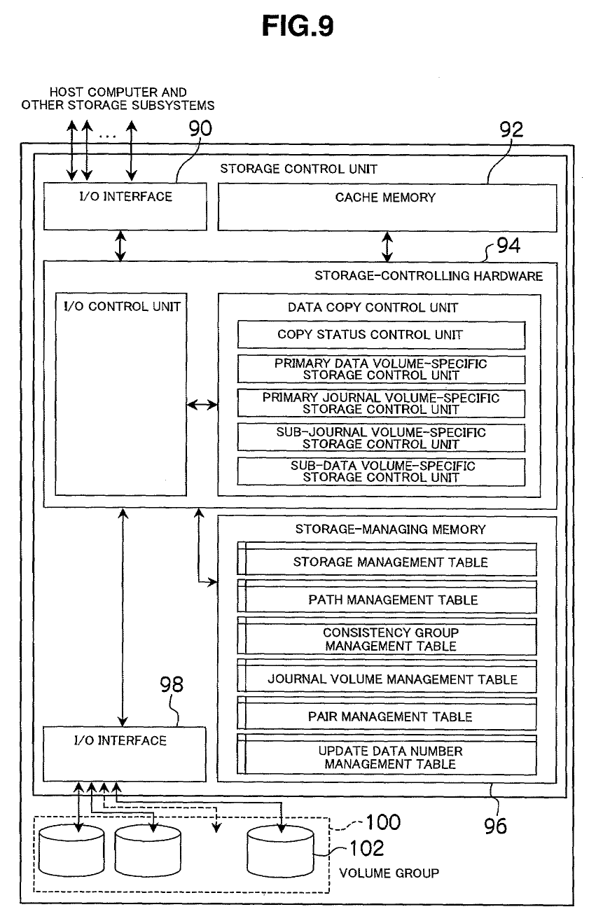

FIG. 9 is a hardware block diagram of a storage subsystem including a data/journal volume at a main/remote site. The storage control unit includes an I/O interface 90 connected to the host computer and other storage subsystems, cache memory 92, storage-controlling hardware 94, storage-managing memory 96, and I/O interface 98.

The storage-controlling hardware 94 includes an I/O control unit and a data copy control unit.

The data copy control unit includes a copy status control unit, primary data volume-only storage control unit, primary journal volume-only storage control unit, sub-journal volume-only storage control unit, and sub-data volume-only storage control unit.

The storage-managing memory 96 stores a storage management table, path management table, consistency group management table, journal volume management table, pair management table, and update data number management table.

The I/O interface 98 controls the input/output of data to/from the memory device 100, which provides volumes 102. The I/O interface 90 is an interface with the host computer and other storage subsystems.

The I/O control unit in the storage-controlling hardware 94 inputs/outputs data to/from the volume groups managed in the storage subsystems, in response to requests from the host computer and the data copy control unit. When a request from the host computer is an update request or remote copy information setting request, the I/O control unit transfers it to the data copy control unit.

The data copy control unit is in charge of executing control for remote copy. The copy status control unit in the data copy control unit analyzes an I/O request and, if the request is a request for setting remote copy information in its own storage subsystem, it sets the remote copy information. Meanwhile, if the request is a request for setting the remote copy information in another storage subsystem, it transfers the request to the other storage subsystem via the I/O interface 90.

If the request is another type of request addressed to the own storage subsystem, the copy status control unit transfers it to the storage control unit 92 in accordance with the role of its own storage subsystem (primary/sub volume-only storage subsystem, or primary/sub journal volume storage subsystem).

The primary data volume-only storage control unit is hardware in charge of executing control when its own storage subsystem is a primary data volume-only storage subsystem.

The primary data volume-only storage control unit judges, with reference to the pair management table, whether or not an input-requested volume is paired with another volume; and if so, it ascertains a relevant consistency group ID by referring to the pair management table and a relevant in-use primary journal volume and its alternative primary journal volume by referring to the consistency group management table. It then transfers the update data to the in-use primary journal volume and the alternative primary journal volume.

The primary journal volume-only storage control unit is hardware in charge of executing control when its own storage subsystem is a primary journal volume-only storage subsystem. It ascertains the consistency group of the update data sent from a primary data volume-only storage subsystem; obtains an update data number by referring to the update data number management table; and stores the update data in a relevant journal volume(s) while assigning the obtained update data number to the update data.

The primary journal volume-only storage subsystem assigns update data numbers to pieces of update data, in the order the pieces of update data were received from the primary data volume-only storage subsystem.

In addition, if the storage-controlling hardware has an in-use primary journal volume in its own storage subsystem, it monitors the content of that volume and, if that volume stores data, it transfers that data to the corresponding in-use sub-journal volume and its alternative sub-journal volume.

The sub-journal volume-only storage control unit is hardware in charge of executing control when its own storage subsystem is a sub-journal volume-only storage subsystem. It stores data sent from a primary journal volume-only storage subsystem in a sub-journal volume.

In addition, if the sub-journal volume-only storage control unit has an in-use sub-journal volume in its own storage subsystem, it sorts the pieces of data stored in that volume in the order of the update data numbers assigned in a relevant primary journal volume-only storage subsystem; and transfers them to a relevant sub-data volume sequentially.

The sub-data volume-only storage control unit is hardware in charge of executing control when its own storage subsystem is a sub-data volume-only storage subsystem. It stores data sent from a sub-journal volume-only storage subsystem in a sub-data volume.

The storage-managing memory is a memory for managing the statuses of storage subsystems and the remote copy information. The storage management table is for managing the statuses of the storage subsystems. This table is the same as the corresponding table managed in the host computer (FIG. 3).

The path management table is a table for managing the settings and statuses of paths between the storage subsystems. This table is the same as the corresponding table managed in the host computer (FIG. 4).

The consistency group management table is a table for managing the consistency groups and the journal volumes belonging to these consistency groups. This table is the same as the corresponding table managed in the host computer (FIG. 5).

The journal volume management table is a table for managing the journal volume information. This table is the same as the corresponding table managed in the host computer (FIG. 6). The pair management table is a table for managing the information for remote copy pairs. This table is the same as the corresponding table managed in the host computer (FIG. 7).

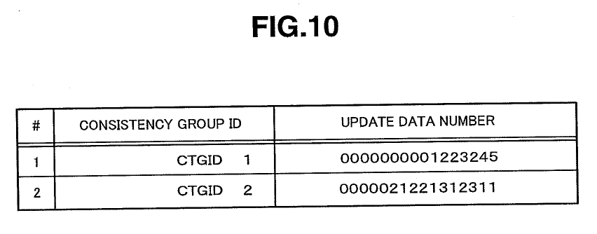

The update data number management table is a table for managing the update data numbers assigned in the primary journal volume-only storage subsystems. FIG. 10 shows the format of this table. An update data number is managed for each consistency group. Each time a primary journal volume-only storage subsystem receives an update data input from a primary data volume-only storage subsystem, it increments the update data number, assigns an update data number to the update data, and stores the update data in a relevant primary journal volume. By referring to the update data numbers, the sub-journal volume-only storage subsystems can maintain the time order of pieces of update data in the different sub-data volumes.

When a primary data volume-only storage subsystem at the main site receives a write access request from the host computer, it stores update data in its cache memory; and hands over the control to the I/O control unit in its storage-controlling hardware.

If necessary, the I/O control unit transfers the request to the data copy control unit (see FIG. 9). Having received the request from the I/O control unit, the data copy control unit passes it to the copy status control unit. If necessary, the copy status control unit passes the request to the storage control units in the relevant storage subsystem.

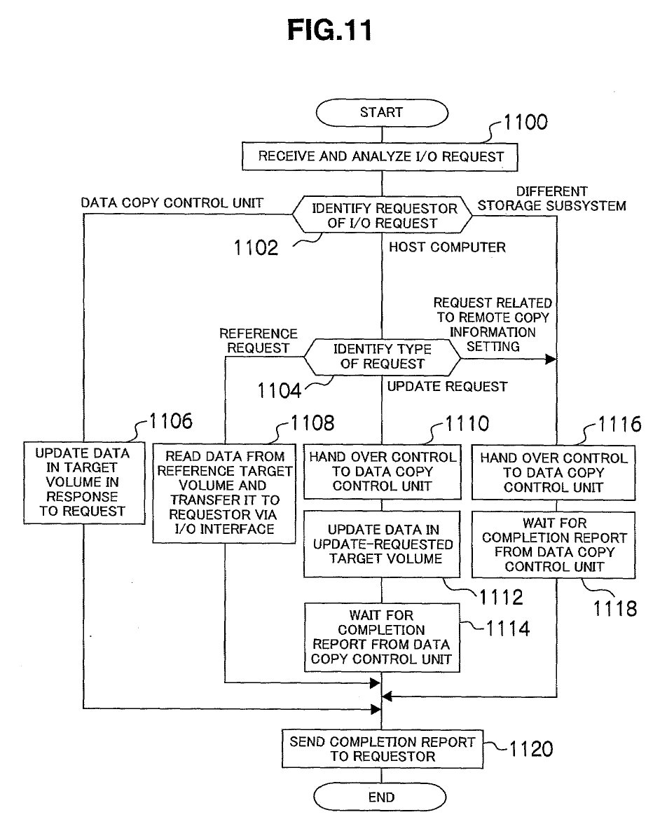

FIG. 11 is a flowchart explaining the control executed by the I/O control unit in the storage-controlling hardware shown in FIG. 9. When the I/O control unit receives an I/O request, it analyzes the request (STEP1100). It then identifies the requestor of the I/O request (STEP1102). If the requester is the data copy control unit, it updates data in a target volume in response to the request (STEP1106); and sends a completion report to the requestor (STEP1120).

If the requester is another storage subsystem, the I/O control unit hands over the control to the data copy control unit (STEP1116); and waits for a completion report from the data copy control unit (STEP1118). Meanwhile, if the requester is the host computer, the I/O control unit identifies the type of the request (STEP1104). If the request is a volume reference request, the I/O control unit reads data from the reference target volume; and transfers it to the requester via the I/O interface (STEP1108).

Meanwhile, if the request is a volume update request, the I/O control unit hands over the control to the data copy control unit (STEP1110); and the data copy control unit updates the data in the update-requested target volume (STEP1112). The I/O control unit waits for a completion report from the data copy control unit (STEP1114); and sends a completion report to the requester (STEP1120).

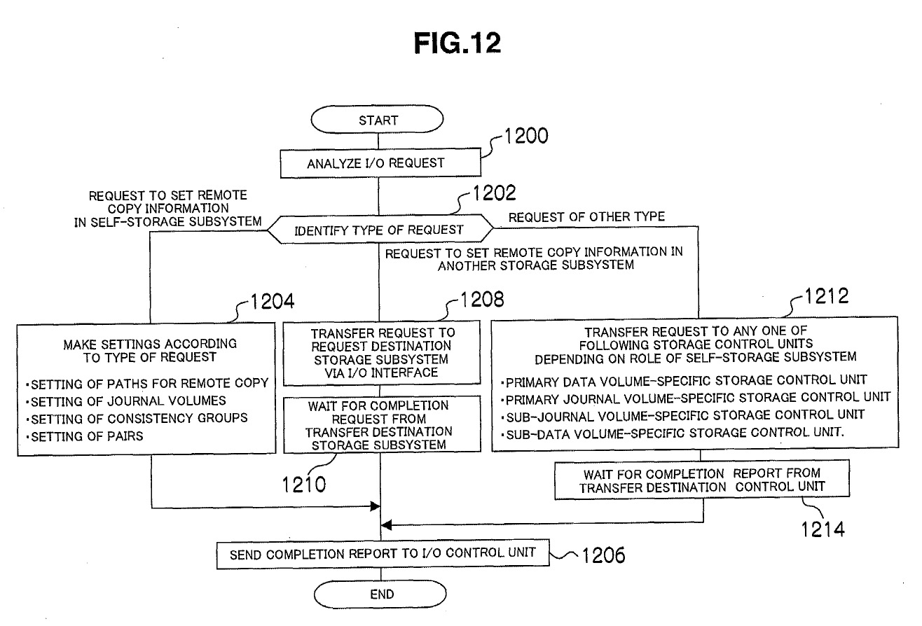

FIG. 12 is a flowchart explaining the control executed by the copy status control unit. The copy status control unit analyzes an I/O request (STEP1200); and identifies the type of the request (STEP1202). If the request is a request to set remote copy information in its own storage subsystem, the copy status control unit sets the remote copy information in accordance with the type of request (STEP1204). This setting involves setting paths, journal volumes, consistency groups and copy pairs for the remote copy. The copy status control unit then sends a completion report to the I/O control unit (STEP1206).

If the request is a request to set remote copy information in another storage subsystem, the copy status control unit transfers it to the request-receiving storage subsystem via the I/O interface 90 (STEP1208).

The copy status control unit then waits for a completion request from the transfer destination storage subsystem (STEP1210). If the request is of a type other than those described above, the copy status control unit transfers, depending on the role of its own storage subsystem, the request to the storage control unit in a primary data volume-only storage subsystem, the storage control unit in a primary journal volume-only storage subsystem, the storage control unit in a sub-journal volume-only storage subsystem, or the storage control unit in a sub-data volume-only storage subsystem (STEP1212). It then waits for a completion report from a transfer destination control unit (STEP1214); and sends a completion report to the I/O control unit.

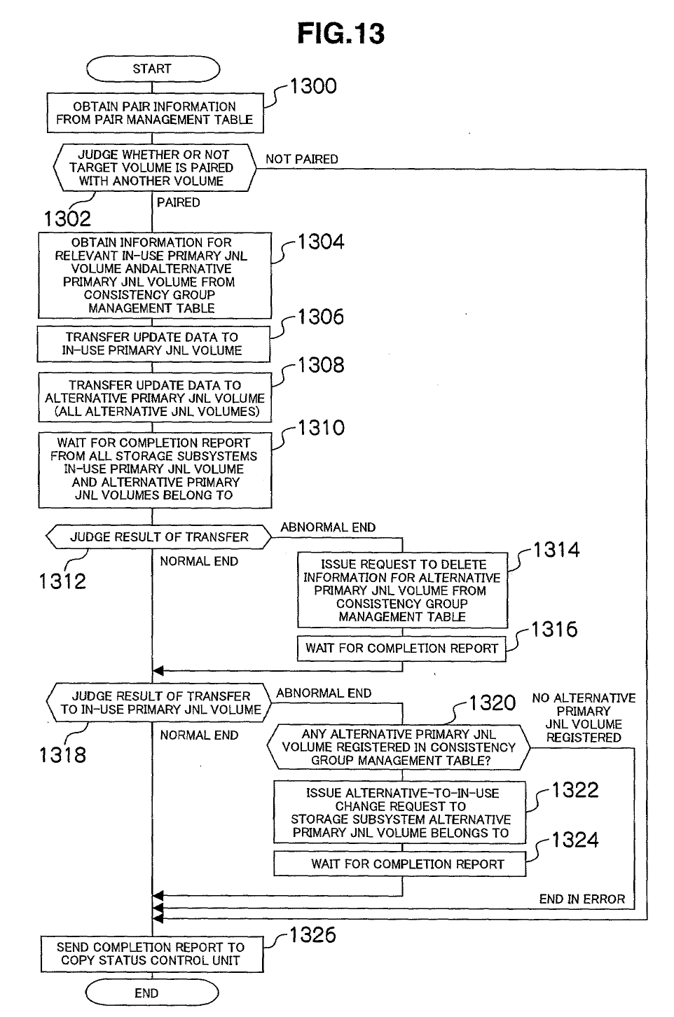

FIG. 13 is a flowchart explaining the operations performed by a storage control unit in a primary data volume-only storage subsystem. At the commencement of this flowchart, the storage control unit obtains pair information for a target volume from the pair management table (STEP1300). It then judges whether or not the target volume is paired with another volume (STEP1302). If the target volume is not paired, the storage control unit sends a completion report to the copy status control unit (STEP1326).

If the target volume is paired with another volume, the storage control unit obtains the information for the relevant in-use primary journal volume and its alternative primary journal volume from the consistency group management table (STEP1304). It then transfers the update data to that in-use primary journal volume (STEP1306).

The storage control unit then transfers the update data to the alternative primary journal volume (STEP1308). If there is more than one alternative primary journal volume, the storage control unit transfers the update data to all the alternative primary journal volumes.

The storage control unit then waits for a report on whether or not the update data has been stored in the in-use primary journal volume and the alternative primary journal volume(s), from the storage subsystems these journal volumes belong to (STEP1310). It then judges the result of transfer of the update data to the alternative primary journal volume(s) (STEP1312).

If the result shows the failure of the transfer of the update data to the alternative primary journal volume(s), the storage control unit issues, to the storage subsystem the in-use primary journal volume belongs to, a request to delete the information for that alternative primary journal volume(s) from the consistency group management table (STEP 1314). This request is issued as a request for setting remote copy information. The storage control unit then waits for a request completion report from the request-receiving storage subsystem (STEP1316).

Meanwhile, if the result shows a successful transfer of the update data to the alternative primary journal volume(s), the storage control unit judges whether or not the update data has been transferred to the in-use primary journal volume (STEP1318).

If the judgment result is negative, the storage control unit judges whether or not an alternative primary journal volume is registered in the consistency group management table (STEP1320). If no alternative primary journal volume is registered, the flowchart ends in error. Meanwhile, if an alternative primary journal volume is registered, the storage control unit issues, to the storage subsystem that alternative primary journal volume belongs to, a request to change that alternative primary journal volume to an in-use primary journal volume (STEP1322). This request is issued as a remote copy information setting request. It then waits for a completion report (STEP1324).

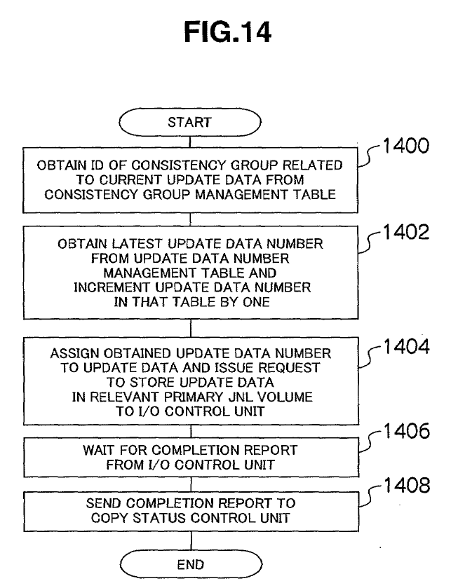

FIG. 14 is a flowchart explaining the control executed by the storage control unit in a primary journal volume-only storage subsystem when receiving update data from a primary data volume-only storage subsystem. The storage control unit ascertains, by referring to the consistency group management table, the ID of the consistency group the update data-sending primary data volume-only storage subsystem belongs to (STEP1400).

The storage control unit then obtains the latest update data number from the update data number management table; and increments the update data number in that table by one (STEP1402). It then assigns the thus-obtained update data number to the update data; and issues a request to store the update data in the relevant primary journal volume to the I/O control unit (STEP1404). It then waits for a completion report from the I/O control unit (STEP1406); and sends a completion report to the copy status control unit (STEP1408).

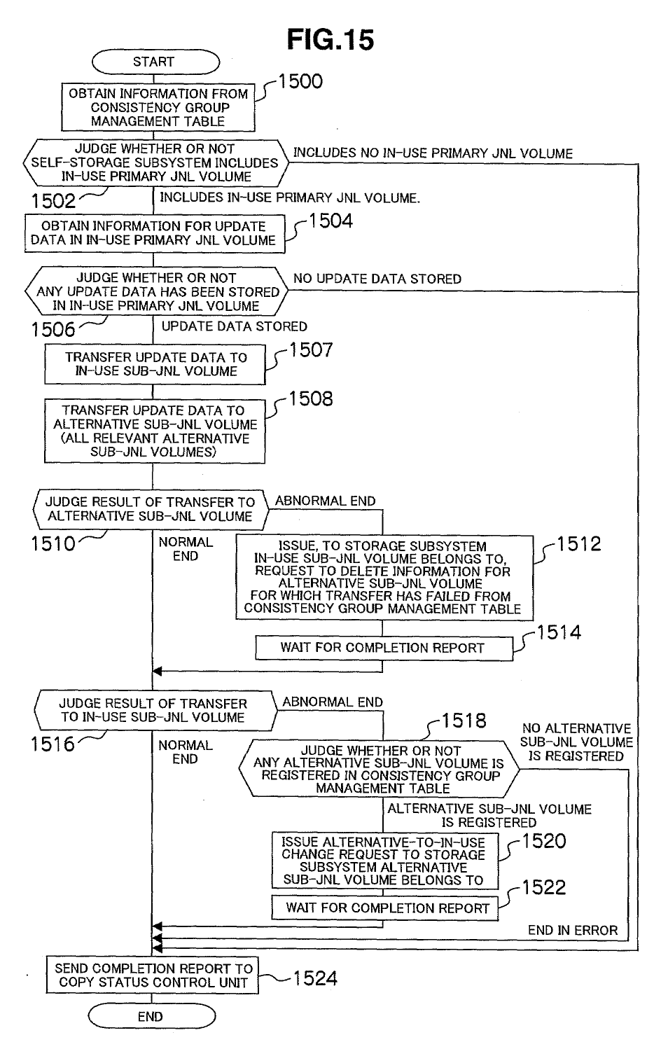

FIG. 15 is a flowchart explaining the control executed by the storage control unit in a primary journal volume-only storage subsystem when transferring update data to a sub-journal volume-only storage subsystem.

At the commencement of this flowchart, the storage control unit obtains relevant information from the consistency group management table (STEP1500); and judges whether or not its own storage subsystem includes an in-use primary journal volume (STEP1502). If there is no in-use primary journal volume, the storage control unit sends a completion report to the copy status control unit (STEP1524).

Meanwhile if the own storage subsystem has an in-use primary journal volume, the storage control unit obtains the information for the update data in that in-use primary journal volume (STEP1504). It then judges whether or not any update data has been stored in the in-use primary journal volume (STEP1506). If there is no such data, it terminates the processing. Meanwhile, if any update data has been stored, the storage control unit transfers that update data to the relevant in-use sub-journal volume (STEP1507).

The storage control unit also transfers the update data to the corresponding alternative sub-journal volume (STEP1508). If there is more than one alternative sub-journal volume, it sends the update data to all the alternative sub-journal volumes.

The storage control unit then judges the result of transferring the update data to the alternative sub-journal volume(s) (STEP1510). If the result is abnormal, the storage control unit issues, to the storage subsystem the in-use sub-journal volume belongs to, a request to delete the information for that alternative sub-journal volume(s) from the consistency group management table (STEP1512). This request is issued as a remote copy information setting request. The storage control unit then waits for a request completion report from the request-receiving in-use sub-journal volume-only storage subsystem (STEP1514).

If the transfer result is normal, the storage control unit then judges the result of transferring the update data to the in-use sub-journal volume (STEP1516). If the result is abnormal, the storage control unit judges whether or not any alternative sub-journal volume is registered in the consistency group management table (STEP1518). If no alternative sub-journal volume is registered, the flowchart ends in error because remote copy from the primary journal volume to the sub-journal volume is impossible.

Meanwhile, if an alternative sub-journal volume is registered, the storage control unit issues, to the storage subsystem that alternative sub-journal volume belongs to, a request to set that alternative sub-journal volume as an in-use sub-journal volume (STEP1520). This request is issued as a remote copy information setting request. The storage control unit then waits for a completion report (STEP1522). If the result of transferring the update data to the in-use sub-journal volume is normal, the storage control unit sends a remote copy completion report to the copy status control unit.

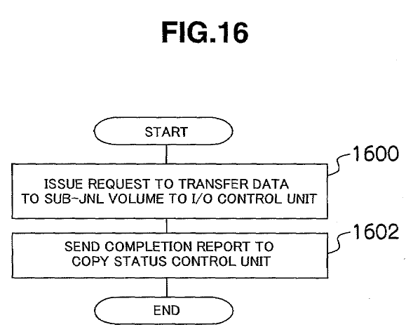

FIG. 16 is a flowchart explaining the control executed by the storage control unit in a sub-journal volume-only storage subsystem when receiving update data from a primary journal volume-only storage subsystem.

The storage control unit issues, to the I/O control unit in its own storage subsystem, a request to transfer data to the sub-journal volume (STEP1600). The I/O control unit then sends a completion report to the copy status control unit (STEP1602).

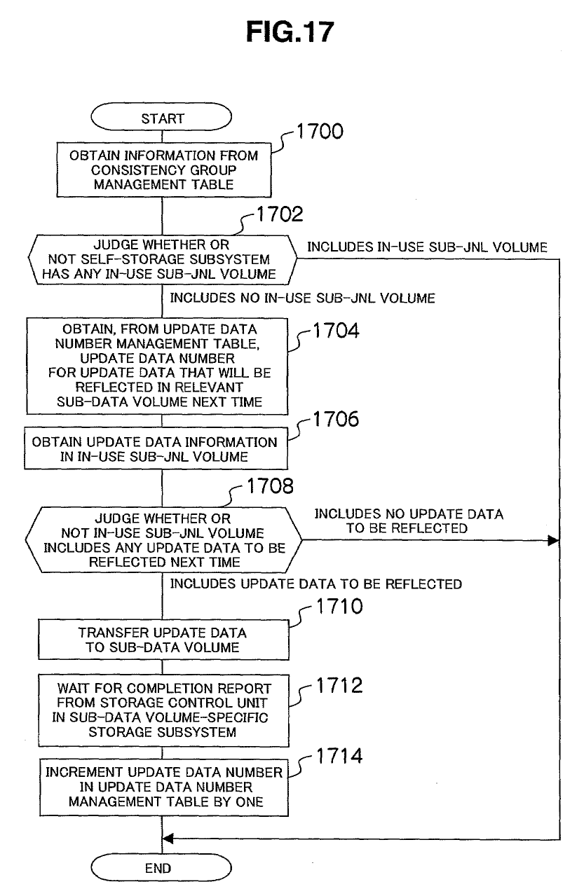

FIG. 17 is a flowchart explaining the control executed by the storage control unit in a sub-journal volume-only storage subsystem when transferring update data to a sub-data volume-only storage subsystem.

The storage control unit obtains relevant information from the consistency group management table (STEP1700); and judges whether or not its own storage subsystem has any in-use sub-journal volume (STEP1702). If there is no in-use sub-journal volume, the storage control unit terminates the processing.

Meanwhile, if the own storage subsystem has an in-use sub-journal volume, the storage control unit obtains, from the update data number management table, the update data number of the update data that is going to be reflected in a relevant sub-data volume (STEP1704).

The storage control unit then obtains the update data information in the in-use sub-journal volume (STEP1706). If the in-use sub-journal volume does not include any update data to be reflected in a sub-data volume, the storage control unit terminates the processing, whereas if the in-use sub-journal volume includes such data, the storage control unit transfers it to the sub-data volume (STEP1708, STEP1710).

The storage control unit in the sub-journal volume-only storage subsystem waits for a report from the storage control unit in the sub-data volume-only storage subsystem indicating completion of storage of the update data in the sub-data volume (STEP1712). It then increments the update data number in the update data number management table by one (STEP1714).

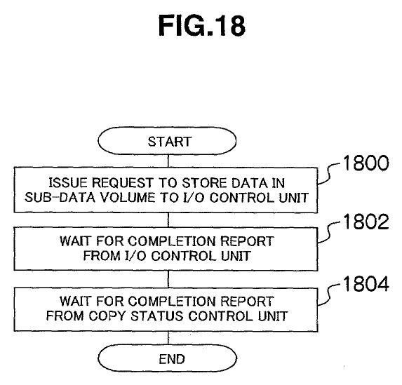

FIG. 18 is a flowchart explaining the control executed by the storage control unit in a sub-data volume-only storage subsystem. The storage control unit issues a request to store data in a sub-data volume to the I/O control unit (STEP1800). The I/O control unit issues an update data transfer request to a relevant sub-journal volume-only storage subsystem. It then receives the update data; stores it in a relevant sub-data volume; and sends a completion report to the copy status control unit (STEP1802, STEP1804).

In the remote copy system according to this invention, primary journal volumes and sub-journal volumes are provided in different storage subsystems from those having data volumes, pieces of update data for primary data volumes and sub-data volumes are collected in these journal volumes, and alternative journal volumes are provided for the in-service journal volumes.

In the remote copy system shown in FIG. 1, when a failure occurs in an in-use journal volume, an available journal volume is searched for from among the alternative journal volumes and the found journal volume is set to be an in-use journal volume. f

A failure in an in-use journal volume at the main site is detected when a primary data volume-only storage subsystem tries to transfer update data to the in-use journal volume.

A failure in access to an in-use journal volume at the remote site is detected when a primary journal volume-only storage subsystem tries to transfer update data to the in-use sub-journal volume-only storage subsystem at the remote site.

A storage subsystem that has detected a failure issues a switch command to the relevant storage subsystem having an alternative primary/sub journal volume. The command-receiving storage subsystem overwrites the consistency group management table in its own storage subsystem.

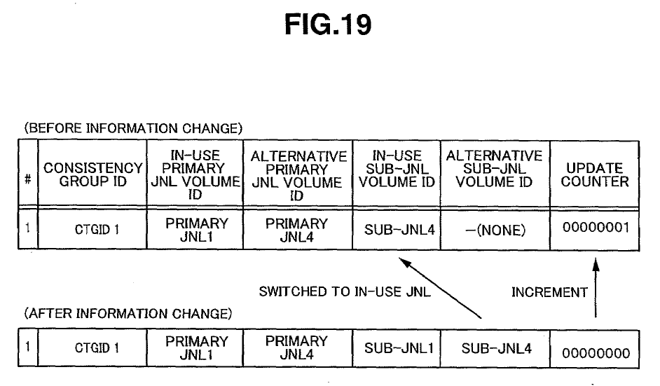

FIG. 19 shows, as an example, changes made in the information in the consistency group management table when a failure occurs in an in-use sub-journal volume.

When a failure occurs in the sub-journal volume JNL1, the sub-journal volume JNL4, which is an alternative sub-journal volume for the sub-journal volume JNL1, is switched from an alternative to an in-use sub-journal volume in the consistency group management table. The ID of the alternative sub-journal volume is registered in the in-use sub-journal volume ID section. Here, because now there is no alternative sub-journal volume anymore, “none” is entered in the alternative sub-journal volume ID section. Thus, the newly-set in-use sub-journal volume is used as a data transfer source for the relevant sub-data volume. Incidentally, the update counter for the management table is incremented by one.

The above changes in the consistency group management table are reflected in the host computer and other storage subsystems as follows. Transfer-related information in the consistency group management table is attached to I/O requests from the host computer and data transfer requests between storage subsystems.

A request-receiving storage subsystem (data copy control unit) compares the information in the consistency group management table it receives with the information for the consistency group management table in its own storage subsystem.

As a result of the comparison, if the information in the own storage subsystem is older (the value of the update counter is smaller), the data copy control unit updates the consistency group management table in its own storage subsystem.

On the contrary, if the information in its own storage subsystem is newer, the data copy control unit sends an error report to the requester, indicating that relevant in-use journal volumes do not match. Having received the error report, the requestor updates the information in its consistency group management table based on the information in the request-receiving storage subsystem and sends a retry request.

When a failure occurs in an alternative journal volume, relevant primary/sub data volume-only storage subsystems issue a request to the storage subsystem the relevant in-use journal volume belongs to, to delete the information for the faulty alternative journal volume from its consistency group management table. The information for this change is reflected in the host computer and other storage subsystems in the same manner as described above.

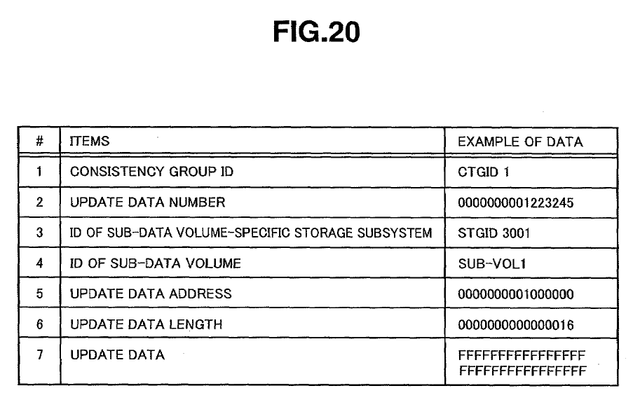

Explanations will be given below to the frame of update data transferred from a primary journal volume to a sub-journal volume, with reference to FIG. 20. The frame is composed of pieces of data corresponding to each item in FIG. 20: #1 indicates the ID of the consistency group a pair belongs to; #2 indicates the update data number assigned in a primary journal volume-only storage subsystem, the update data number being assigned for each consistency group; #3 is the ID of the storage subsystem the sub-data volume belongs to; #4 indicates the ID of the sub-data volume; #5 indicates the destination address in the sub-data volume where the update data will be stored; #6 indicates the update data length; and #7 indicates the update data (having a variable length, i.e., the data length may be designated in #6). Although it was explained in the above-mentioned embodiment that a failure in access to a sub-journal volume at the remote site is detected by a primary journal volume-only storage subsystem at the main site, a different configuration, like as the one below, may be adopted.

Sub-journal volume-only storage subsystems at the remote site issue read requests to the primary journal volume-only storage subsystems at regular time intervals, regardless of whether they have received any update data from them. The sub-journal volume-only storage subsystems make 0-byte read-access to the primary journal volume-only storage subsystem even when there is no data is to be transferred.

At the main site, the primary journal volume-only storage subsystems regularly check whether they have received read requests from the sub-journal volume-only storage subsystem at the remote site and, in the absence of a read request, they decide that a failure has occurred in access to the journal volumes at the remote site.

Alternatively, the storage subsystems at the main site may determine the occurrence of failures, by issuing write requests to the remote site, in the same manner as in issuing read requests.

In the aforementioned embodiment, primary journal volumes and sub journal volumes are provided in different storage subsystems from data volume-only storage subsystems; however, these journal volumes may alternatively be provided in the data volume-only storage subsystems and other storage subsystems may be made to access these journal volumes.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A remote copy system comprising,
a main site constituting a first storage system having a primary volume, said primary volume receiving update data from a host computer; and
a remote site-constituting second storage system having a sub volume paired with said primary data volume, the update data being copied to said sub volume paired from the primary data volume, wherein
the first storage system comprises:
a plurality of storage subsystems;
a plurality of primary data volumes existing across the storage subsystems; and
a primary journal volume shared by the primary data volumes, and
the first storage system sequences pieces of update data the host computer sends to the primary data volumes and collectively stores the sequenced pieces of update data in the primary journal volume, and
the second storage system comprises:
a plurality of storage subsystems;
a plurality of sub-data volumes existing across the storage subsystems; and
a sub-journal volume which the pieces of update data in the primary data volumes are copied to, and
the second storage system sorts the pieces of update data in the sub-journal volume in accordance with their sequence, and allocates the sorted pieces of update data to the sub-data volumes to write them therein.

2. A remote copy system for copying data from a storage system at a main site to a storage system at a remote site, wherein
the storage system at the main site comprises:
a plurality of storage subsystems each having a primary data volume; and
a storage subsystem, different from the above storage subsystems, including a primary journal volume where the pieces of update data the host computer sends to the primary data volumes are stored while being sequenced,
the primary data volumes form a consistency group in which a data update sequence is guaranteed,
the storage system at the remote comprises:
a plurality of storage subsystems each having a sub-data volume copy-paired with one of the primary data volumes; and
a storage subsystem, different from the above storage subsystems, including a sub-journal volume which the pieces of update data stored in the primary journal volume are copied to,
the sub-data volumes form a consistency group, the storage subsystem having the sub-journal volume allocates the pieces of update data in the sub-journal volume to the sub-data volumes to write them therein.

3. A remote copy system copying data from a first storage system to a second storage system, wherein
the first storage system comprises: a plurality of storage subsystems; a plurality of primary data volumes; and a primary journal volume, the primary data volumes belong to different storage subsystems in the plurality of storage subsystems, a host computer write-accesses each primary data volume, and pieces of update data for the primary data volumes are written in the primary journal volume in order,
the second storage system comprises: a plurality of storage subsystems; a plurality of sub-data volumes copy-paired with the primary data volumes respectively; and a sub-journal volume to which the pieces of update data the host computer sends to the primary data volumes are copied, and
based on the order of the pieces of update data stored in the sub-journal volume, the pieces of update data for the primary data volumes are allocated to the sub-data volumes to be written therein.

4. A remote copy system where data is copied between a plurality of storage systems, comprising:
a first storage system;
a second storage system; and
a communication path connecting the first storage system and the second storage system,
wherein,
the first storage system comprises:
a first storage subsystem including a first primary data volume;
a second storage subsystem including a second primary data volume; and
a primary journal volume, and
a host computer write-accesses the first primary data volume or the second primary data volume and update data for the first primary data volume and the second primary data volume is written in the primary journal volume,
the second storage system comprises:
a third storage subsystem including a first sub-data volume;
a fourth storage subsystem including a second sub-data volume; and
a sub-journal volume which the update data the host computer sends to the first primary data volume and the second primary data volume is copied to, and
based on the order of the pieces of update date stored in the sub-journal volumes, the second storage system writes the update data for the first primary data volume from the sub-journal volume to the first sub-data volume, and writes the update data for the second primary data volume in the second sub-data volume.

5. The remote copy system according to claim 4, wherein asynchronous copy is performed between the primary journal volume and the sub-journal volume.

6. The remote copy system according to claim 4, wherein the primary journal volume is provided in a different storage subsystem from the first storage subsystem and the second storage subsystem.

7. The remote copy system according to claim 4, wherein the sub-journal volume is provided in a different storage subsystem from the third storage subsystem and the fourth storage subsystem.

8. The remote copy system according to claim 4, wherein the first storage system stores the pieces of update data for the first primary data volume and the second primary data volume in the primary journal volume while sequencing the pieces of update data; and transfers them to the sub-journal volume, and
the second storage system reads, from the sub-journal volume, the pieces of update data transferred from the primary journal volume; and writes them in the first sub-data volume or the second sub-data volume based on the sequence of the pieces of update data.

9. The remote copy system according to claim 4, wherein
the host computer issues a plurality of commands to update data in the first primary data volume and the second primary data volume, and
the first storage system assigns serial numbers to the pieces of update data used for each command in order to sequence them, and stores the pieces of update data in the primary data volumes with these serial numbers.

10. The remote copy system according to claim 4, wherein the first sub-data volume and the second sub-data volume form a consistency group in which the update order of the pieces of update data is guaranteed.

11. The remote copy system according to claim 10, wherein
the first storage subsystem further comprises a third primary data volume,
the second storage subsystem further comprises a fourth primary data volume,
the third storage subsystem further comprises a third sub-data volume,
the fourth storage subsystem further comprises a fourth sub-data volume,
the primary journal volume stores the pieces of update data the host computer sends to the third primary data volume and the fourth primary data volume,
the update data for the third primary data volume is copied to the third sub-data volume,
the update data for the fourth primary data volume is copied to the fourth sub-data volume,
the first sub-data volume and the second sub-data volume form a first consistency group,
the third sub-data volume and the fourth sub-data volume form a second consistency group, and
the order of the pieces of update data is set for the first consistency group and the second consistency group separately.

12. The remote copy system according to claim 4, wherein:
the first storage subsystem further comprises a third primary data volume;
the second storage subsystem further comprises a fourth primary data volume;
the third storage subsystem further comprises a third sub-data volume;
the fourth storage subsystem further comprises a fourth sub-data volume;
the primary journal volume consists of a first primary journal volume and a second primary journal volume;
the sub-journal volume consists of a first sub-journal volume and a second sub-journal volume;
the first primary journal volume stores the update data the host computer sends to the first primary data volume and the second journal volume;
the second primary journal volume stores the update data the host computer sends to the third primary data volume and the fourth primary data volume;
the update data for the third primary data volume is copied to the third sub-data volume;
the update data for the fourth primary data volume is copied to the fourth sub-data volume;
the update data stored in the first primary journal volume is copied to the first sub-data volume;
the update data stored in the second primary journal volume is copied to the second sub-data volume;
the first primary data volume and the second primary data volume form a first consistency group; and
the third primary data volume and the fourth primary data volume form a second consistency group.

13. The remote copy system according to claim 4, wherein at least one of the primary journal volume and the sub-journal volume is provided with another journal volume so that, when a failure occurs in the access to the primary journal volume or the sub-journal volume, that other journal volume becomes an alternative for the primary journal volume or the sub-journal volume.

14. A method for controlling remote copy whereby data is copied from a plurality of duplication source data volumes at a main site to a plurality of duplication destination data volumes at a remote site, comprising:
storing a plurality of pieces of update data a host computer continuously issues to the duplication source data volumes, in the duplication source data volumes;
storing the pieces of update data in a first journal volume at the main site;
sequencing the pieces of update data when receiving them in the first journal volume;
remote-copying the pieces of update data stored in the first journal volume to a second journal volume at a remote site; and
allocating the pieces of update data in the second journal volume to the duplication destination data volumes based on their sequence and storing them therein.
